(19) United States
(12) Patent Application Publication
(10) Pub. No.: US 2011/0264547 A1
(43) Pub. Date: Oct. 27, 2011

(54) ONLINE BOOKING METHOD AND SYSTEM

(76) Inventors: Daniel Trang, Markham (CA); Keith Chung, Toronto (CA)

(21) Appl. No.: 13/094,826

(22) Filed: Apr. 27, 2011

Related U.S. Application Data
(60) Provisional application No. 61/328,191, filed on Apr. 27, 2010.

(51) Int. Cl. G06Q 30/00

(52) U.S. Cl. 705/26.1

(57) ABSTRACT

A computer-implemented method for listing available resources in a client-server e-commerce system. The method comprises receiving from a first seller a first listing of at least one resource offered by the first seller and receiving from a second seller a second listing of at least one resource offered by the second seller. For each resource of the first and second listings, the method further comprises receiving an indication of attributes of the resource, receiving an indication of relationships between the attributes, and based on the received indication of attributes and the indication of relationships, dividing the attributes into at least two sets, wherein the dividing of the attributes is characteristic of an organizational structure offering services.

### FIELD OF THE INVENTION

The present invention relates generally to e-commerce systems, and more particularly to a system for booking of resources offered by sellers to customers desiring those resources.

### BACKGROUND OF THE INVENTION

With the advent of the Internet, many organizations and businesses began to offer their customers the option of booking appointments via an Internet service (an “online booking system”). This initially proved to be difficult since the creation of an online booking system often required a large amount of custom software and programming. Moreover, it was difficult to create a system that was representative of the business. For example, the nature of some businesses may be such that appointments are typically booked with one member of a class of employees, e.g. massage appointments which may be made with any masseuse working at a given time. In contrast, other businesses may be such that appointments are typically made with a specific employee for a specific service, e.g. hairstylist providing a perm.

Furthermore, it has been observed that customers often cancel previously made appointments. Therefore, there was a need to capture real-time availabilities of resources (e.g. a customer cancels a massage several hours before her scheduled appointment and therefore the masseuse reserved for that customer becomes available). Without a system flexible enough to accommodate such unexpected events, resources which might otherwise have been consumed would have gone idle (e.g. another customer could have been treated by that masseuse).

Also, since the creation of an online system was challenging, adapting the system as the nature of the business or business model evolved proved difficult.

Over time, more generic online systems were created. However, these were still generally directed toward specific, niche areas, such as for example, travel websites providing hotel/cars/airlines reservations and restaurant websites. Even the more generic online systems were problematic as they typically could only accommodate a single business model, for example, a timeslot-based appointment model for an individual unique resource (e.g. a hairstylist). Businesses that did not operate by the timeslot-based model could not be accommodated by the system. Clearly, this was problematic as different businesses operate using a variety of different models.

Therefore, there is clearly a need for a generic online booking web platform that can by used by a variety of businesses operating with a variety of business models.

### SUMMARY OF THE INVENTION

In a first aspect of the invention, there is provided a computer-implemented method for listing available resources in a client-server e-commerce system. The method includes receiving from a first seller a first listing of at least one resource offered by said first seller and receiving from a second seller a second listing of at least one resource offered by the second seller. For each resource of the first and second listings, receiving an indication of attributes of the resource; receiving an indication of relationships between the attributes; and based on the received indication of attributes and the indication of relationships, dividing the attributes into at least two sets, wherein said dividing of the attributes is characteristic of an organizational structure offering services.

In a second aspect of the invention, there is provided a computer-implemented method for presenting service option availability in a client-server e-commerce system. The method comprises receiving from a seller a definition of a service option offered by the seller; receiving from the seller an indication of a plurality of attributes of the service option; receiving from the seller an indication of at least one relationship between the attributes of the service option; based on the received at least one relationship, dividing the attributes into at least two sets wherein the dividing of the attributes is characteristic of an organizational structure offering services.

In a third aspect of the invention, there is provided a computer-implemented method for storing a plurality of service listings in a client-server e-commerce system. The method includes defining a first service dimension and a plurality of members of said first service dimension, each member of the first plurality of members comprising a set of values, wherein each value corresponds to an attribute of a given service. The method further comprises storing the first plurality of members of the first service dimension; defining a second service dimension and a plurality of members of the second service dimension, each member of the second plurality of members comprising a set of values, wherein each value corresponds to another attribute of the given service; and storing the second plurality of members of the second service dimension. The method even further includes defining a third service dimension and a plurality of members of the third service dimension, each member of the third plurality of members comprising a set of values, wherein each value defines a relationship between a member of the first service dimension and a member of the second service dimension; and storing the third set of members of said third service dimension. The first, second and third service dimensions are collectively characteristic of an organizational structure offering services.

In a fourth aspect of the invention, there is provided a computer-implemented method for presenting a service option in a client-server e-commerce system. The method includes receiving from a seller a first plurality of values wherein each of the first plurality of values corresponds to a service attribute in a first service dimension, the first plurality of values constituting an instance of the first service dimension; receiving from a seller a second plurality of values wherein each of the second plurality of values corresponds to a service attribute in a second service dimension, the second plurality of values constituting an instance of the second service dimension; receiving from a seller at least one definition of a service option, each of the at least one definition comprising an indication of at least one relationship between at least one instance of the first service dimension and at least one instance of the second service dimension; and consequent upon receiving a customer request for viewing available service options, presenting to the customer a representation of identified available service options, wherein the representation depends on at least one received definition of a service option and the at least one instance of the first service dimension corresponding to the at least one received definition of a service option and the at least one instance of the second service dimension corresponding to the at least one received definition of a service option.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a block diagram of a client-server e-commerce system in accordance with an exemplary embodiment of the present invention;

FIG. 2 is a screenshot of a graphical user interface (GUI) screen for registering a user of the e-commerce system of FIG. 1;

FIG. 3 is a screenshot of a graphical user interface (GUI) screen for creating a resource of the e-commerce system of FIG. 1;

FIG. 4 is a screenshot of a graphical user interface (GUI) screen for selecting a region to be associated with a given listing of the e-commerce system of FIG. 1;

FIG. 5 is a screenshot of a graphical user interface (GUI) screen for creating a bulk resource of the e-commerce system of FIG. 1;

FIG. 6 is a screenshot of a graphical user interface (GUI) screen for selecting a category to be associated with a given listing of the e-commerce system of FIG. 1;

FIG. 7 is a screenshot of another graphical user interface (GUI) screen for creating a listing of the e-commerce system of FIG. 1;

FIG. 8 is a screenshot of a graphical user interface (GUI) screen for viewing a profile of a seller in the e-commerce system of FIG. 1

FIG. 9 is a screenshot of a graphical user interface (GUI) screen for creating a resource availability listing for an individual resource of the e-commerce system of FIG. 1;

FIG. 10 is a screenshot of a graphical user interface (GUI) screen for creating a recurring resource availability listing for an individual resource of the e-commerce system of FIG. 1;

FIG. 11 is a screenshot of a graphical user interface (GUI) screen for creating a recurring resource availability listing for a bulk resource of the e-commerce system of FIG. 1;

FIG. 12 is a screenshot of a graphical user interface (GUI) screen for viewing a listing of a seller in the e-commerce system of FIG. 1;

FIG. 13 is a screenshot of a graphical user interface (GUI) screen for viewing the availability of a particular resource and for a given resource listing in the e-commerce system of FIG. 1;

FIG. 14 is a screenshot of a graphical user interface (GUI) screen for a customer booking request for a particular resource and for a given resource listing in the e-commerce system of FIG. 1;

FIG. 15 is a flow diagram depicting a user registration operation at a client computer in the e-commerce system of FIG. 1;

FIG. 16 is a flow diagram depicting a create resource operation at a client computer in the e-commerce system of FIG. 1;

FIG. 17 is a flow diagram depicting a create resource listing operation at a client computer in the e-commerce system of FIG. 1;

FIG. 18 is a flow diagram depicting a create availability operation at a client computer in the e-commerce system of FIG. 1;

FIG. 19 is a flow diagram depicting an alternative create availability operation at a client computer in the e-commerce system of FIG. 1;

FIG. 20 is a flow diagram depicting a view service operation at a client computer in the e-commerce system of FIG. 1;

FIG. 21 is a flow diagram depicting a create user operation at a server computer in the e-commerce system of FIG. 1;

FIG. 22 is a flow diagram depicting a create resource operation at a server computer in the e-commerce system of FIG. 1;

FIG. 23 is a flow diagram depicting a create listing operation at a server computer in the e-commerce system of FIG. 1;

FIG. 24 is a flow diagram depicting a create availability operation at a server computer in the e-commerce system of FIG. 1;

FIG. 25 is a flow diagram depicting a view service option operation at a server computer in the e-commerce system of FIG. 1;

FIGS. 26 to 33 are block diagrams depicting the manners in which resources may be modelled in the e-commerce system of FIG. 1; and

FIG. 34 is a mockup of a graphical user interface (GUI) screen for defining a resource model in the e-commerce system of FIG. 1.

### DETAILED DESCRIPTION

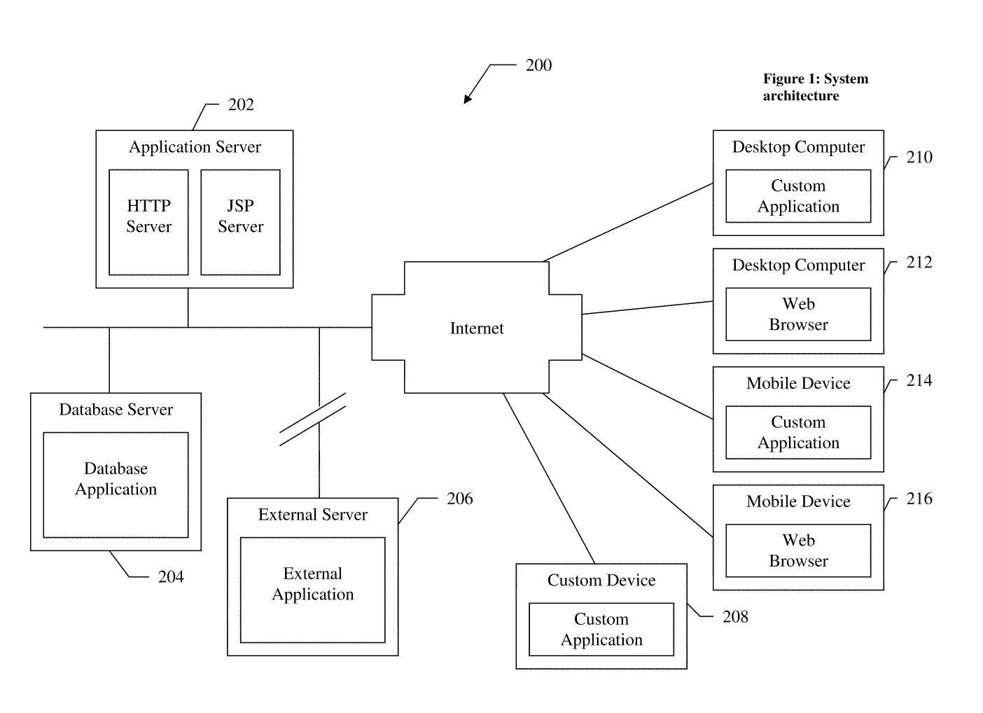

FIG. 1 illustrates an e-commerce system 200 exemplary of an embodiment of the present invention. System 200 may include an application server 202, database server 204, external server 206 and clients, desktop computers 210, 212, and mobile devices 214 and 216. System 200 may even include a custom device 208. Each of the aforenoted components of system 200 may be interconnected by way of the Internet in a conventional manner. Alternatively, database server 204, external server 206 and application server 202 may be interconnected by a LAN in a conventional manner instead of the Internet. Each of application server 202, database server 204 and external server 206 may serve one or more of client devices 210, 212, 214, 216 and 208 also in a conventional manner. It may be appreciated that while application server 202, database server 204 and external server 206 are illustrated as separate components, they may hosted on one computing device, or on other configurations of computing devices, as will be known to those skilled in the art.

Application server 202 may include a HTTP server for, for example, delivering and receiving content, such as HTML documents, images, style sheets, and JavaScript, using the hypertext transfer protocol (HTTP). Application server 202 may also include a JSP server for, for example, providing a Java Servlet container.

Database server 204 may include a database application for, for example, organizing, storing, and accessing data necessary to implement e-commerce system 200.

External server 206 may include an external application for, for example, communicating with users of the e-commerce system via channels of communication other than the Internet, such as SMS, MMS, and phone calls.

Desktop computers 210 and 212 may access e-commerce system 200. More specifically, they may communicate with one or more of servers 202, and 206, by way of the Internet, using a standard web browser (e.g. Firefox, Internet Explorer) or using a custom application. Likewise, mobile devices 214 and 216 (e.g. iPhone, Blackberry) may communicate with one or more of servers 202 and 206, by way of the Internet, using a standard mobile web browser (e.g. Blackberry Browser; Safari) or using a custom mobile application.

Custom device 208 may be a device provided by the provider of e-commerce system 200 for the purpose of accessing system 200 in the form of, for example, a point-of-sale computing device.

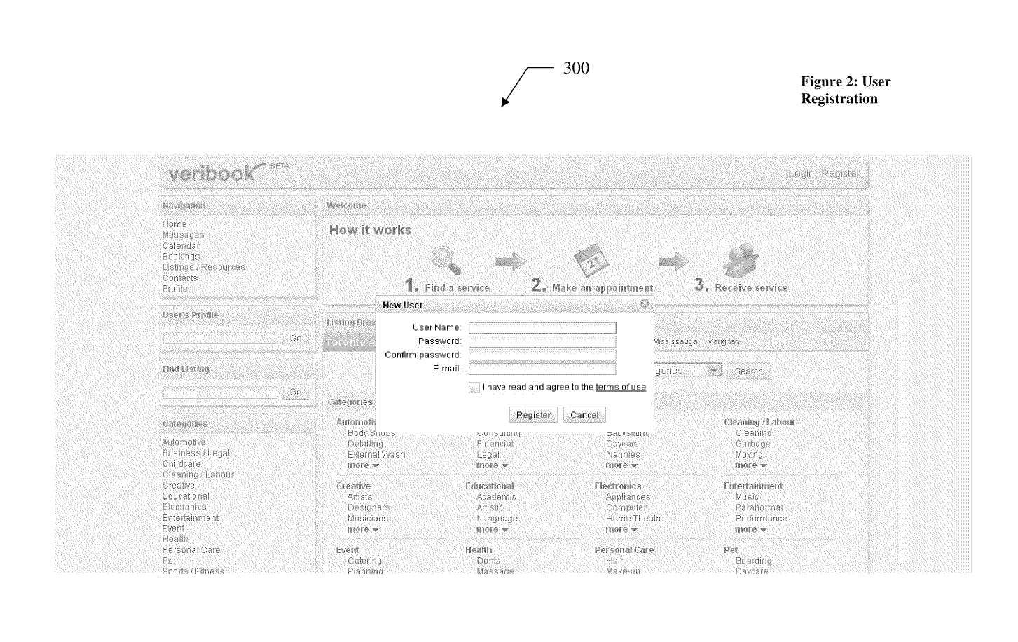

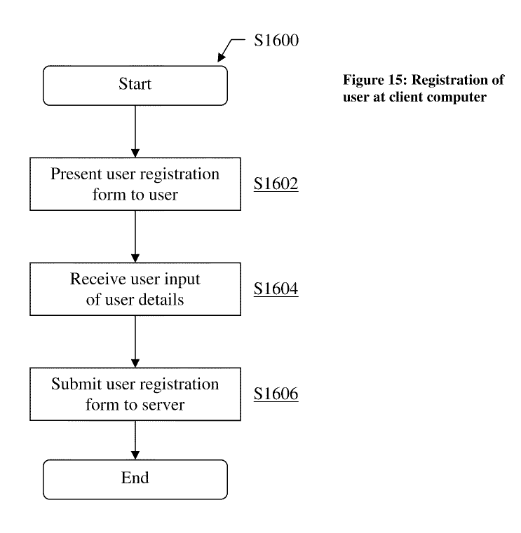

Before a person with a resource to offer (hereinafter “a seller”) may list with system 200 (create a “resource listing”), it may first be required to register with system 200. FIG. 2 is a screenshot of an exemplary GUI screen presented to the seller. The seller may register using one of previously described client devices 210, 212, 214, 216 or 218. In the exemplary embodiment, the seller may register using client device 212 running a web browser such as Firefox. Flowchart S1600 (FIG. 15) illustrates operation of one of the client devices to register the seller. Specifically, and as noted in S1600, a user registration form may be presented to the seller (S1602); the seller's input of its user details may be received (S1604); and the user registration form may be submitted to server 202 (S1606).

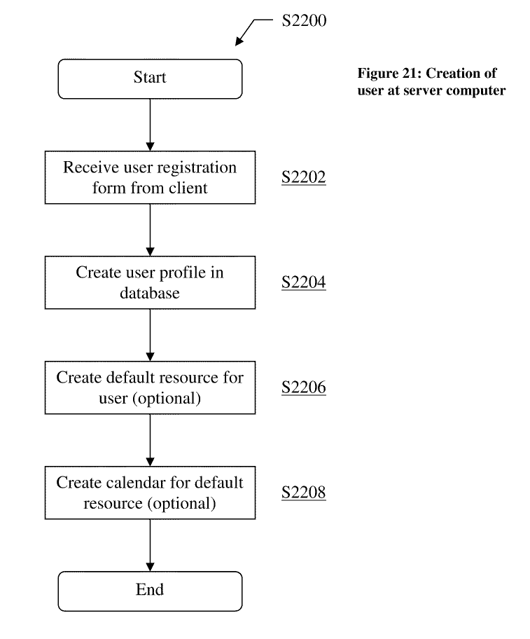

Flow diagram S2200 (FIG. 21) depicts operation at server 202 upon receiving the user registration form from client computer 212 (S2202). Specifically, a user profile may be created (S2204) and optionally, a default resource may be created for the user (S2206). Also optionally, two calendars may be created (S2208), as further detailed below.

A resource may take the form of an individual resource, i.e., a specific employee who provides a service (e.g. John Doe, a math tutor) or a specific item for sale or rent (e.g. rental car). Alternatively, there may exist multiple instances of a resource which can be interchanged (i.e. a “bulk resource”). For example, a bulk resource may be a generic employee or a bulk item (e.g. a car rental company may have fleet of rental cars where cars may be interchanged). In the case of an individual resource, the customer may desire to book a particular individual resource (i.e. the customer wants to book specifically John Doe's services for tutoring math). By contrast, a customer who books a car may be agnostic to the exact car rented and therefore, the available cars may be interchangeable by the car rental company with minimal expected impact on the customer.

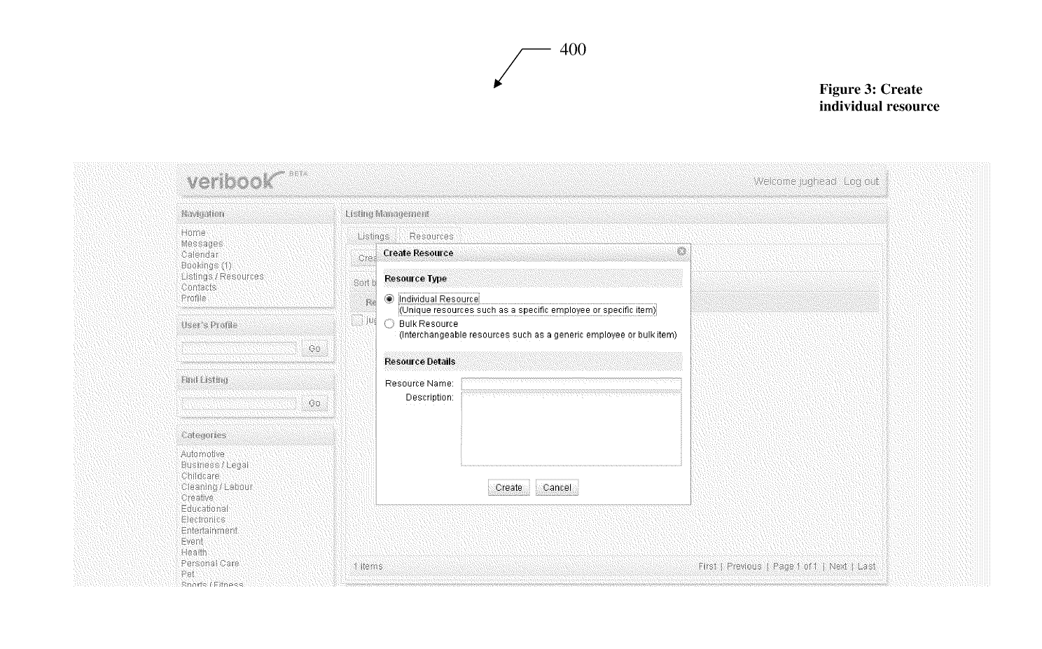

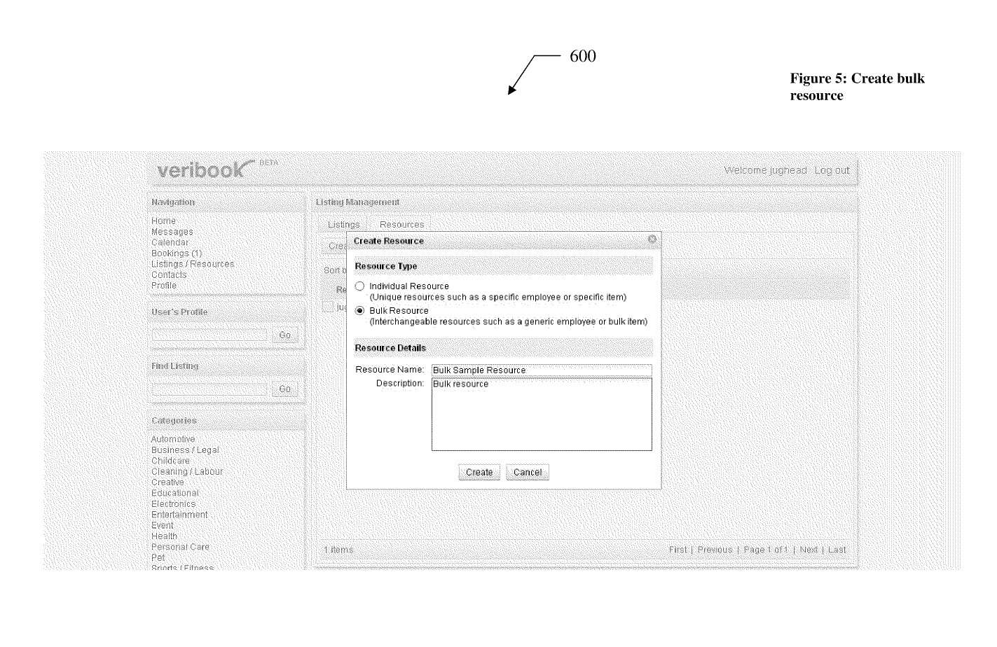

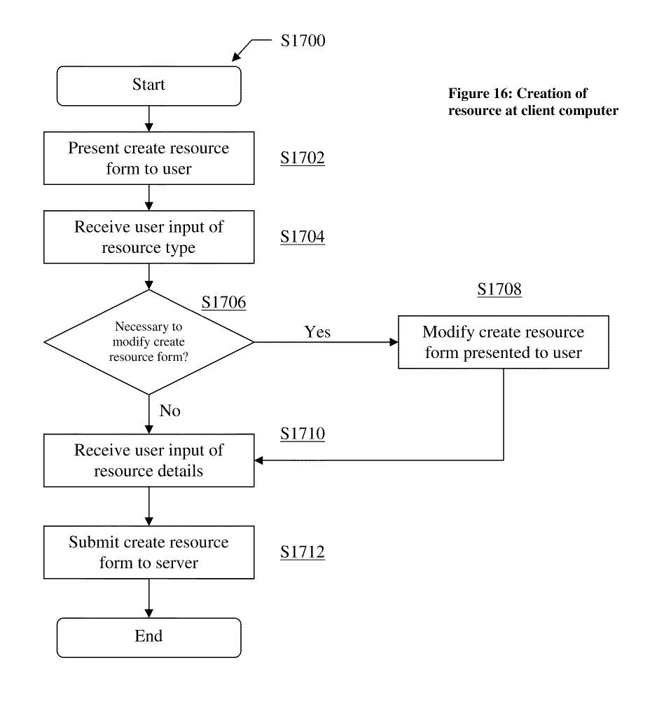

Therefore, when creating a resource the seller may be asked to first specify the resource type. FIG. 3 is a screenshot of a create resource form 400 presented to the seller, and flow diagram S1700 (FIG. 16) depicts operation of client computer 212 when the seller is performing the create resource operation. More specifically, form 400 may be presented to the seller (S1702). Form 400 may contain a radio button menu with two options: individual resource and bulk resource. The seller may indicate the type of resource by clicking the appropriate radio button. Client computer 212 may receive the indicator of the type of resource (S1704) and may on that basis, determine if it is necessary to modify form 400 (S1706, S1708). For example, a particular form may be presented for a bulk resource (e.g. FIG. 5) whereas another form may be presented for an individual resource. Next, the seller may enter further details of the resource, for example, its name in the “Resource name” textbox and a description in the “Description” textbox. Client computer 212 may receive these further details (S1710) and thereafter submit form 400 to server 202 (S1712).

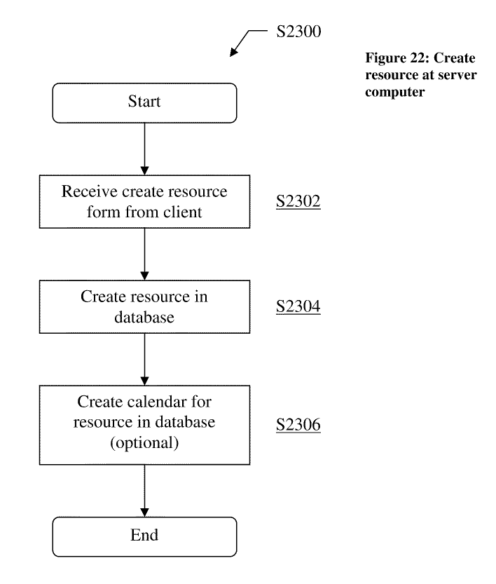

Operation of server 202 upon receipt of form 400 is depicted in flow diagram S2300 (FIG. 22). Upon receiving create resource form 400 (S2302), a resource instance may be created in the database (S2304) and optionally, two calendars may be created for the resource in the database (S2306). One calendar may represent the resource's availability (i.e. “free calendar”), and another calendar may represent the resource's bookings/events (i.e. “busy calendar”). Real-time availability of the resource may be calculated by taking the difference of these two calendars.

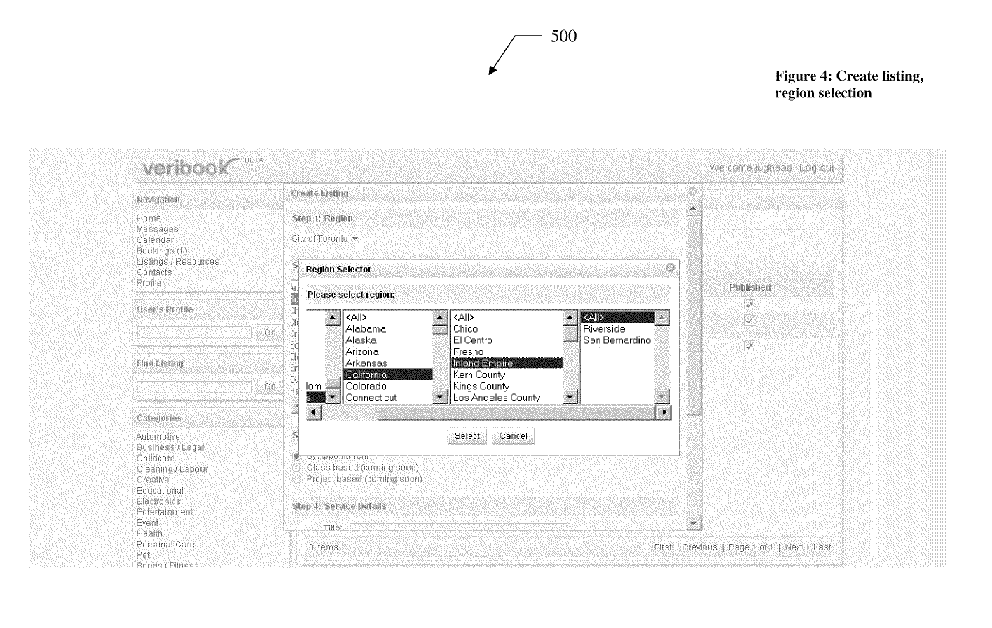

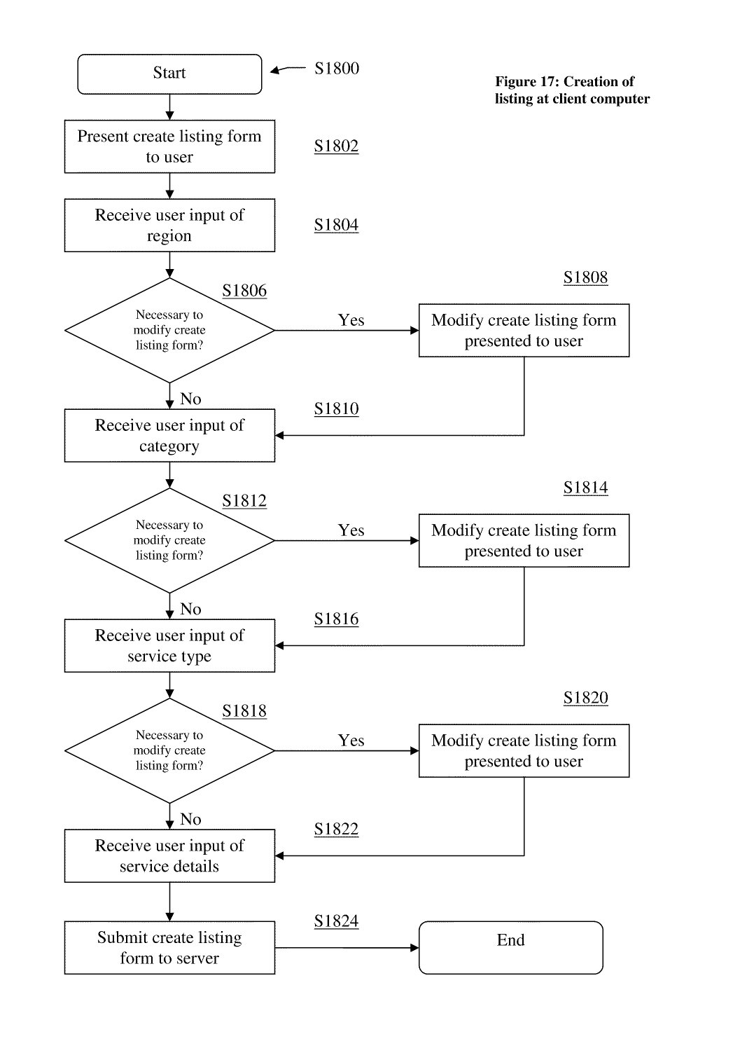

After creating a resource, the seller may next create a listing for the newly created resource. Operation of the resource listing operation on client computer 212 is depicted in flow diagram S1800 (FIG. 17). The seller may be presented with a form to enter information, including to input a region within which the resource listing is being offered (S1802). FIG. 4 is a screenshot of a “Select Region” form 500 containing a selection menu. In the exemplary selection menu shown in FIG. 4, the seller is given the option of selecting a country (not shown), followed by a state with the selected country (e.g. California), followed by a region within the selected state (e.g. Inland Empire), and then yet another sub-region within the selected region (e.g. All).

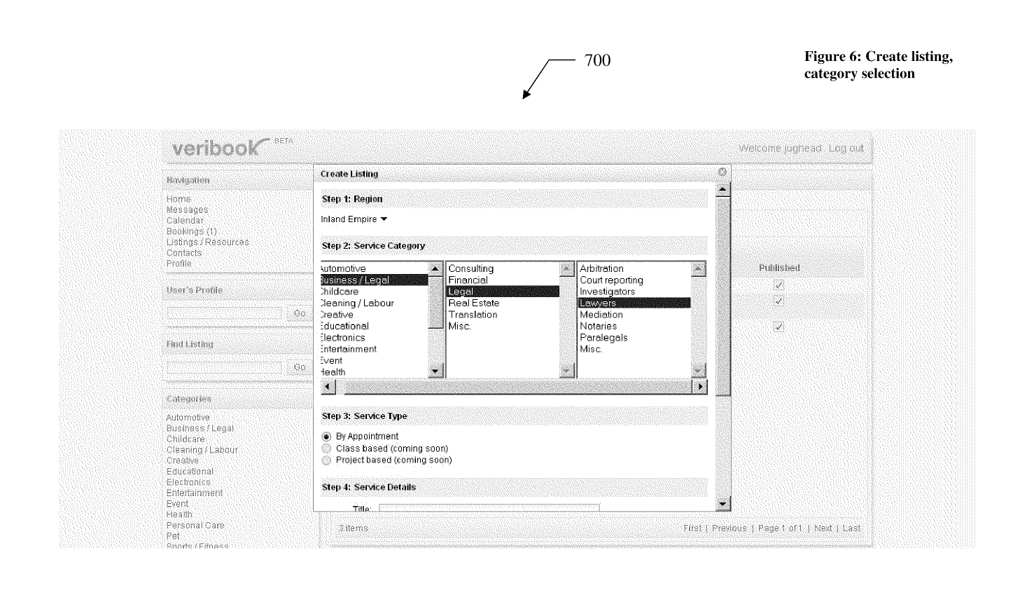

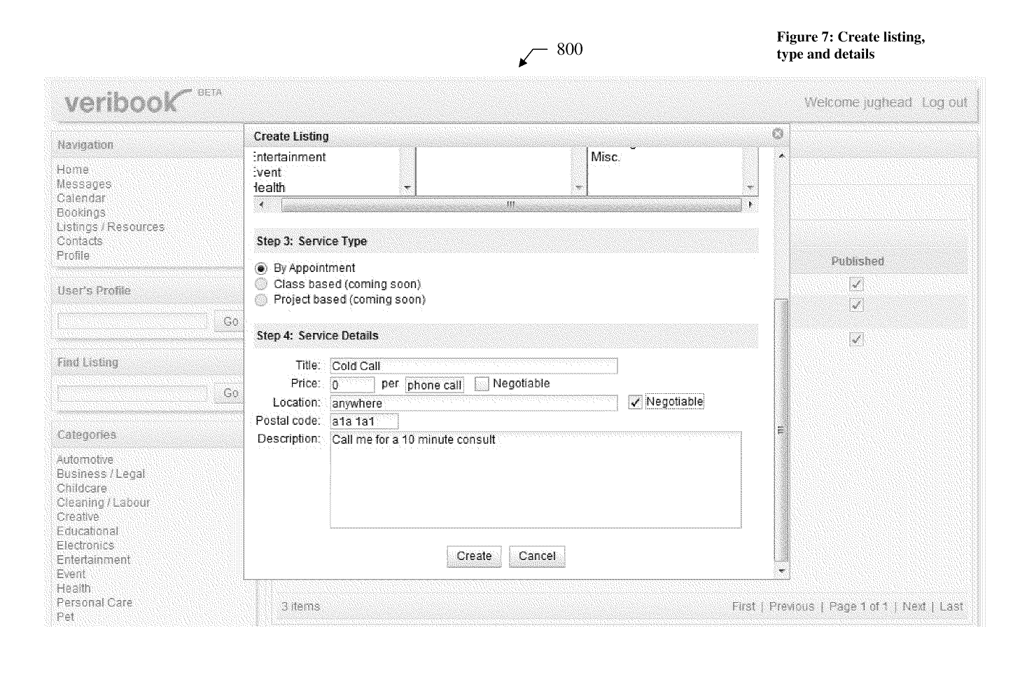

Client computer 212 may receive the indicator of the selected region(s) (S1804) and may on that basis, determine if it is necessary to modify form 700/800 (FIG. 6, FIG. 7) described below (S1806, 51808). Moreover, client computer 212 may modify form 500 and/or form 700/800 depending on whether the seller has previously created individual resource(s) and/or bulk resource(s).

System 200, specifically client computer 212, may next seek service category, service type and service detail information from the seller through form 700 (the continuation of which is shown as form 800) (FIG. 6, FIG. 7, S1810-S1822). As with the “Select Region” form 500, form 700/800 may display a hierarchy of service categories from which the seller may select. Specifically, in FIG. 6, the exemplary seller has indicated that its service category is “Business/Legal”, sub-category, “Legal” and even further “Lawyer”. Client computer 212 may receive an indication of such (S1810) and may on that basis, determine that it is necessary to modify form 700/800 (S1812, S1814), for example, by including an additional field such as “Registration Number” on form 700/800.

As shown, form 700/800 may also contain a “Service Type” section containing a radio button menu with three options: by appointment; class based; and project based. By appointment services are generally offered on a very flexible basis, often between a single seller and a single buyer. Class based services are generally offered on a less flexible basis, at fixed times and locations, and between a single seller and a plurality of buyers. Project based services are generally offered on a flexible basis, but wherein the seller may have only a deadline for completing a task, instead of a specific time period. Additional types (not shown) include rentals, for the rental of locations or objects, and time slot services wherein the appointment timeslots are fixed. The seller may select a type by clicking the appropriate radio button. Client computer 212 may receive an indication of such (S1816) and may on that basis, determine that it is necessary to modify form 700/800 (S1818, S1820), for example, by including an additional field such as “Time Slot Length” on form 700/800.

The seller may also enter service detail information into form 700/800 such as its title, the price at which the service is being offered, the location and a short description of the service (S1822).

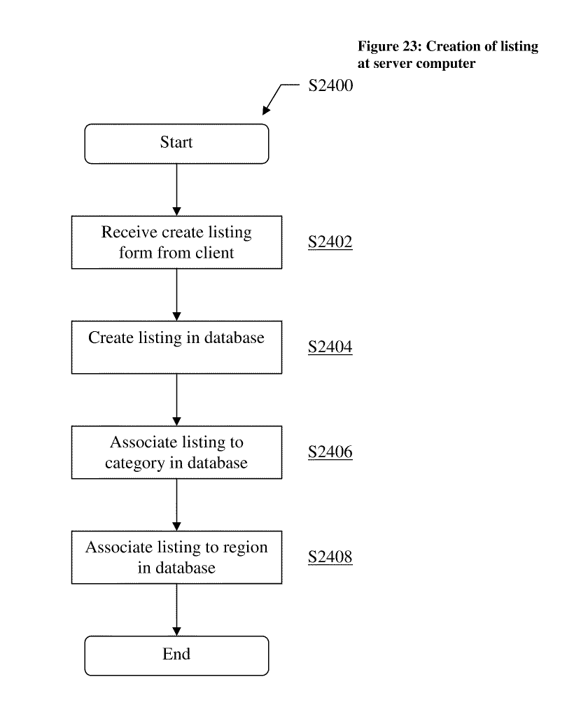

When the seller has completed form 700/800, form 700/800 may be submitted to server 202 (S1824). Operation of server 202 upon receiving form 700 is depicted in flow diagram S2400 (FIG. 23). Specifically, upon receiving create listing form 700/800 (S2402), the server may create an instance of the listing in the database (S2404) and may associate the listing to a category (S2406) and may further associate the listing to a region (S2408).

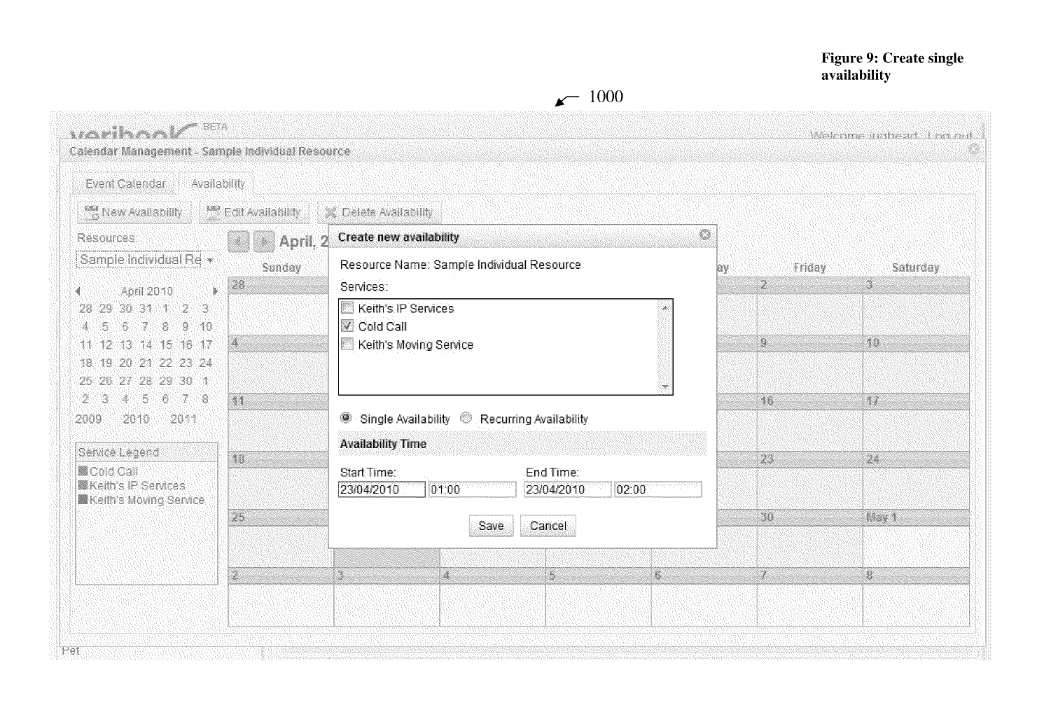

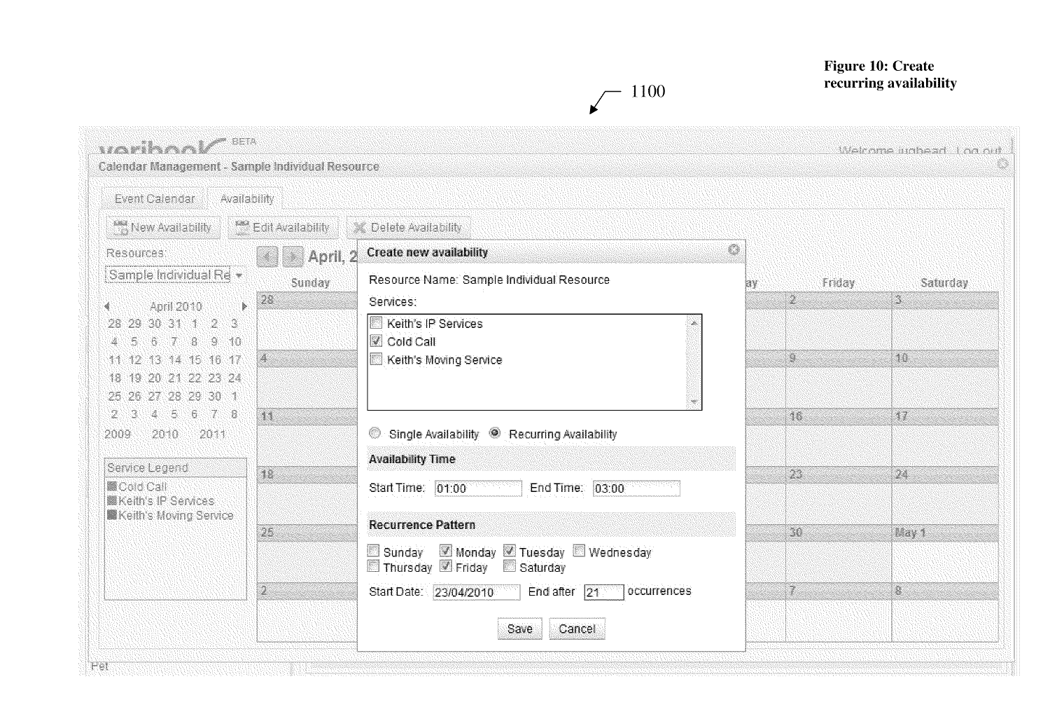

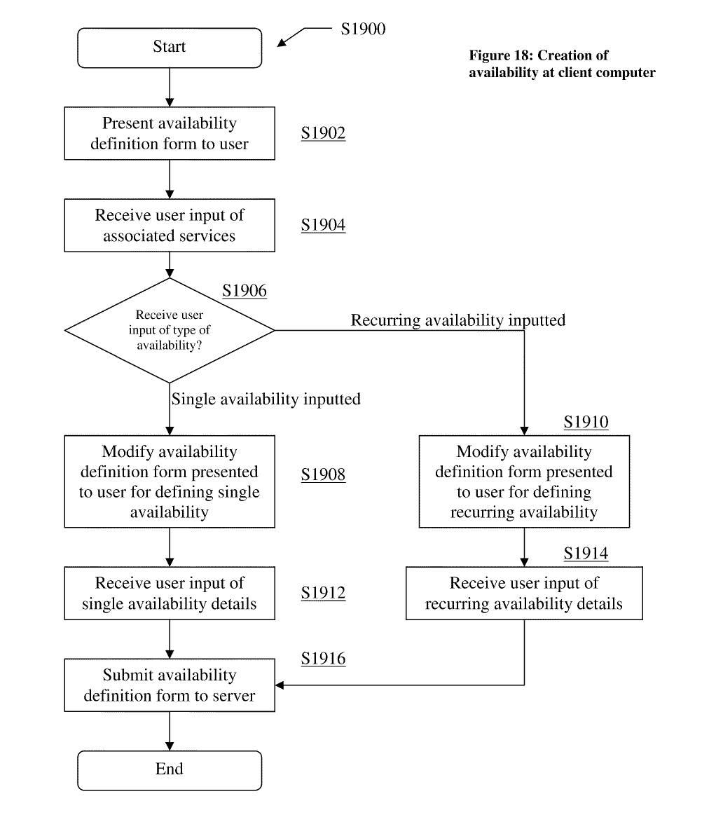

Once the seller has created a resource listing in system 200 as described above, the seller may create availabilities, i.e., the seller may specify when, and in association with which defined listings, the created resource(s) are available to be booked by customers. FIGS. 9-10 and flow diagram S1900 (FIG. 18) depict operation of system 200 to allow a seller to create such availabilities.

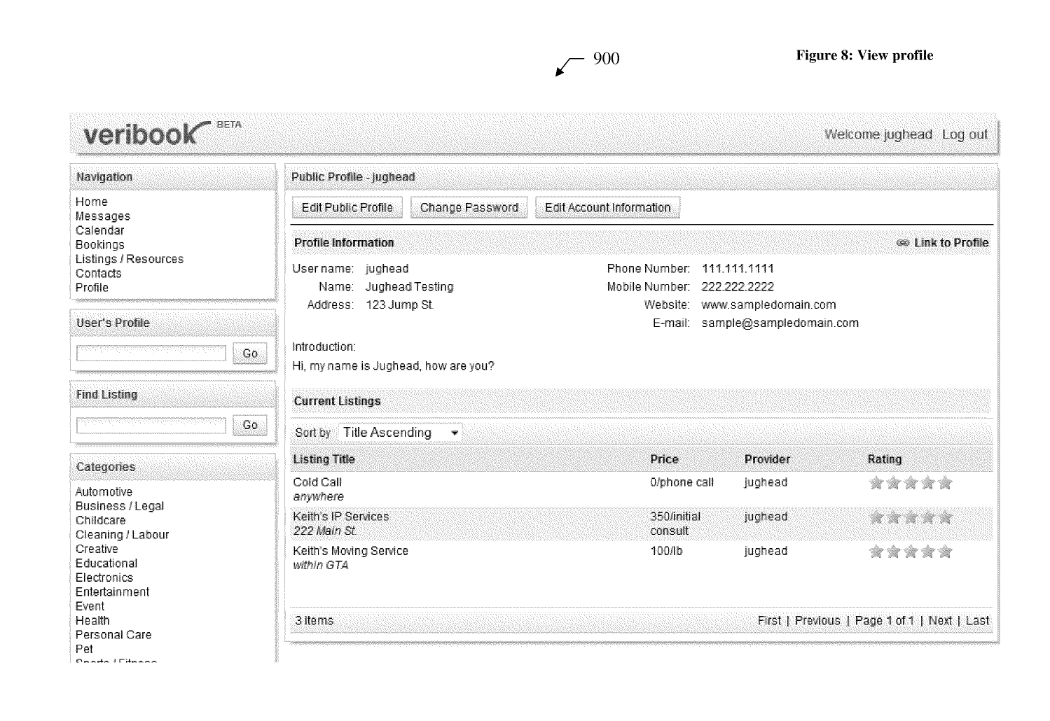

It may be appreciated that a single seller (e.g. a business) may provide several types of services. As illustrated in FIG. 8, a seller whose name is “jughead” has registered with system 200 as providing three types of services: cold call services; IP services and moving services. Jughead may have one or more resources (e.g. employees) who provide the specified services on behalf of jughead. Having defined the services that it provides, the seller (i.e. “jughead”) may specify the times at which its resources are available to provide one or more of the services. Flow diagram S1900 (FIG. 18) depicts operation of client computer 212 during a create availability operation by a seller.

As previously noted, exemplary seller jughead provides IP services, cold call services and moving services. Form 1000 (FIG. 9) may be presented to jughead (S1902) to allow it to define a resource's availability for the service(s) that it wishes to create an availability for (FIG. 18, S1904). Jughead may also subsequently create an availability for each resource it has, i.e. jughead may create an availability for each of its employees (not shown). System 200 may allow jughead to specify either a single instance of an availability (i.e. a one-time only availability) or recurring availability. Depending on which option jughead chooses (S1906), client computer 212 may modify form 1000 accordingly (e.g. the days of the week selection menu may not be presented if single availability is selected) (S1908, S1910), receive the corresponding details (S1912, S1914), and submit form 1000 to server 202 (S1916).

As illustrated in form 1000 (FIG. 9), jughead has specified, by clicking the “cold call” and “single availability” radio buttons, that it desires to create a single availability associated with only its cold call service at the time specified in the “Availability Time” section of form 1000 (i.e. Apr. 23, 2010 from 1:00 to 2:00).

Alternatively, jughead may specify that it desires to create recurring availabilities from 1:00 to 3:00 on Monday, Tuesday, and Friday starting from Apr. 23, 2010, ending after 21 occurrences (FIG. 10).

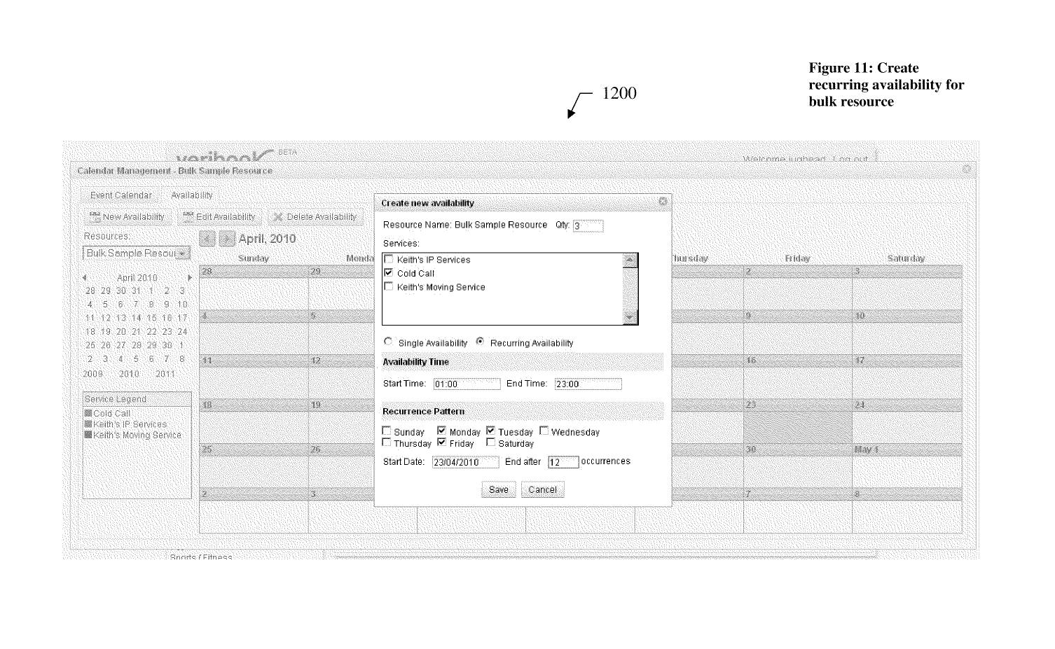

FIG. 11 depicts the scenario in which the seller, e.g. jughead, is offering a bulk resource of quantity 3 for the cold call service, with recurring availability on Monday, Tuesday, and Friday at 1:00 to 23:00 beginning on Apr. 23, 2010 and ending after 12 occurrences. For example, if jughead were, for example, a law firm, this may correspond to three paralegals (i.e. the bulk resources) who are otherwise interchangeable for the purpose of answering cold calls, and who are available to accept cold calls at the times specified.

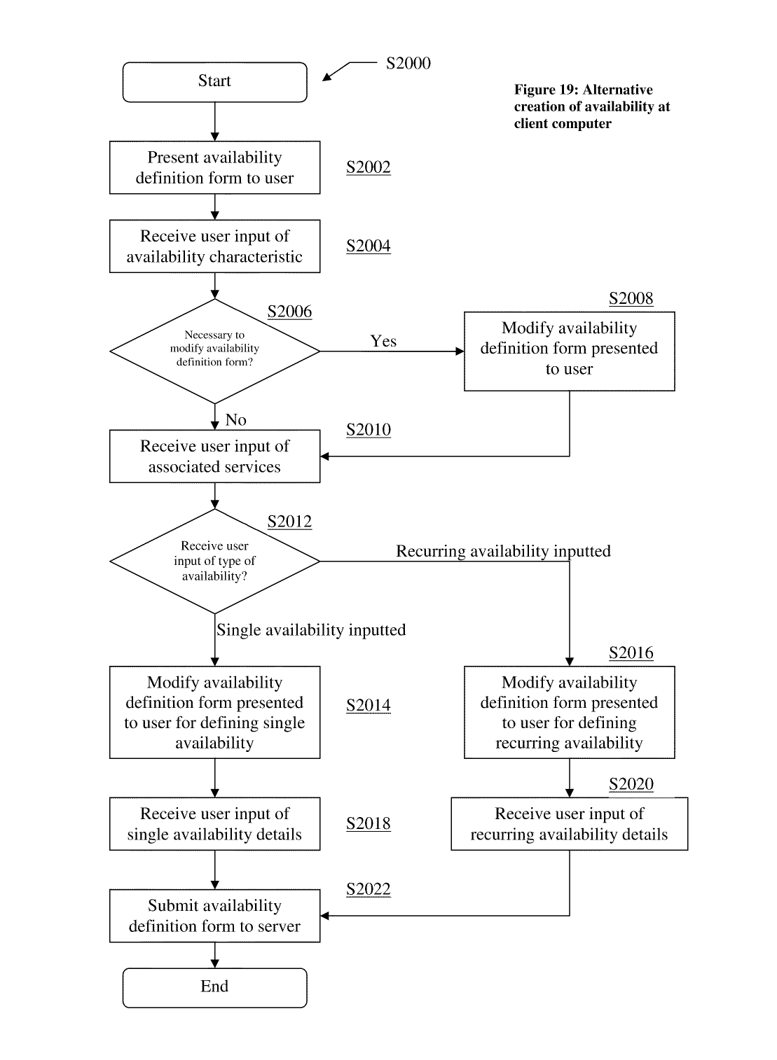

Flow diagram S2000 (FIG. 19) depicts an alternative operation of client computer 212 to allow the exemplary seller, jughead, to perform a create availability operation. More specifically, additional steps (S2004-S2008) are inserted as compared to S1900 to receive an availability characteristic from the user (e.g. a timeslot availability) (S2004), determine if it is necessary to modify form 1000 (S2006), and if so, modify form 1000 (e.g. for example, by including an additional field such as “Time Slot Length” on form 1000) (S2008).

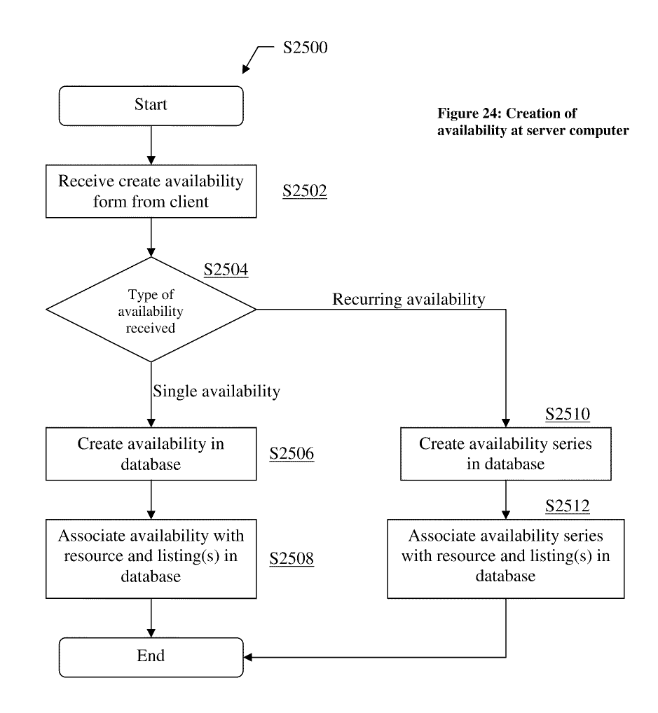

Operation of server 202 to create an availability, upon receiving availability definition form 1000, is depicted in flow diagram S2500 (FIG. 24). In particular, upon receiving availability definition form 1000 (S2502) from client computer 212, the type of availability (i.e. single or recurring) may be determined (S2504). If single availability was specified, then steps S2506 and S2508 may be performed. If recurring availability was specified, steps S2510 and S2512 may be performed.

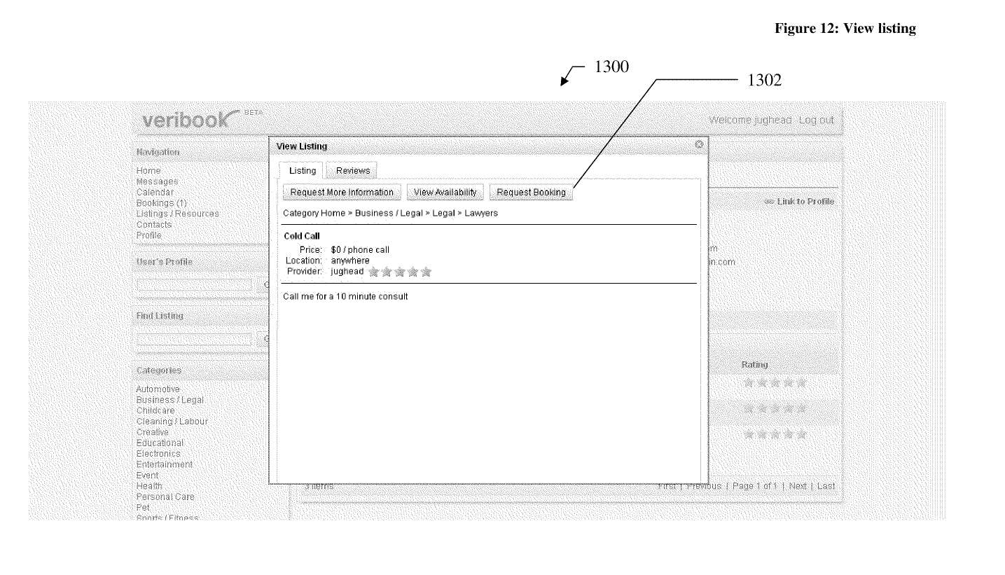

Upon completion of the above-described functions, it may be considered that a seller has completed a service listing (i.e. listing available resources offered by it) for a given resource which listing may then be presented to prospective customers for purchase/booking. An exemplary resource listing that may be presented to prospective customers is shown in FIG. 12.

As previously discussed, a drawback of existing systems is that they were customized to the type of business operated by an offeror/seller of a resource. Therefore, a system that was designed to accommodate, for example, a restaurant business (where the resources offered may be, for example, tables in the restaurant) could not easily be accommodated to accommodate, for example, a student tutoring service (where the resource offered may be, for example, John Doe who teaches math and French and is available in a certain region of town on one day and in another region of town on another day). In other words, it is difficult for, for example, an e-commerce system to accommodate both a restaurateur that wishes to post nightly restaurant seating availability and a tutor that wishes to advertise for students to tutor in two different subjects downtown on certain days of the week and uptown on certain other days, due to the differences between the two types of business models.

Moreover, another drawback of existing systems was that they often lacked understanding of the details of the resources being offered. For example, in the “classified ad” model, the data for the resource listing is represented as natural language text. The classified ad listing system has no understanding of the data within the classified ad and therefore can perform very little automation (eg. determining price, location, service, reminders, confirmation, etc.).

In order to gracefully accommodate resource listings of many types of businesses, conveniently, system 200, in accordance with an exemplary embodiment of the present invention, may model its data in accordance with its knowledge of the characteristics or attributes associated with a resource, as further detailed below.

Notably, once system 200 is provided with an indication of how a business is modelled through, for example, specification of attributes of resources offered by that business, it may be able to automate or derive certain further functions and data. For example, if system 200 “knows” that a service has three levels, gold, silver, bronze, it may automatically correlate the level of service desired by a prospective customer based on the price entered by the prospective customer.

Similarly, and returning to the above example of John Doe, the math tutor, if system 200 “knows” that John works from the downtown location on weekdays, and from the uptown location on weekends, system 200 may offer (and accept) appointments for John at the correct location and at times he is available.

Even further, and notably, system 200 may divide the attributes in a manner in accordance with a characteristic of an organizational structure (eg. business model). For example, system attributes representing a car rental agency type of business may be different from those representing a hair salon type of business.

Other and specific examples of the modelling by system 200 may be as follows:
To offer automated restaurant bookings, it may be necessary to associate the restaurant with a model that represents numerous relatively interchangeable tables, each offering a different number of seats, available for two sittings each evening.
To offer hair salon services, it may be necessary to associate the hair salon with a model that represents multiple stylists, who each offer specific services (e.g. stylist A may offer services X and Y, whereas stylist B may offer services Y and Z). Each stylist is unique and not interchangeable, and pricing is dependent on both the stylist and the service.
To offer the rental of wedding paraphernalia such as chair covers and centerpieces, it may be necessary to associate the rental service with a model that represents multiple different products, each comprising a set of interchangeable items, with pricing dependent on date and product and number of items rented.
To offer class-based services (e.g. a yoga class), a model may be created wherein multiple people may book with a single instructor in a given timeslot.
To offer services that repeat over time (e.g. a series of 10 weekly yoga lessons), a model may be created wherein repeated appointments are automatically generated upon subscribing to the first of the series.

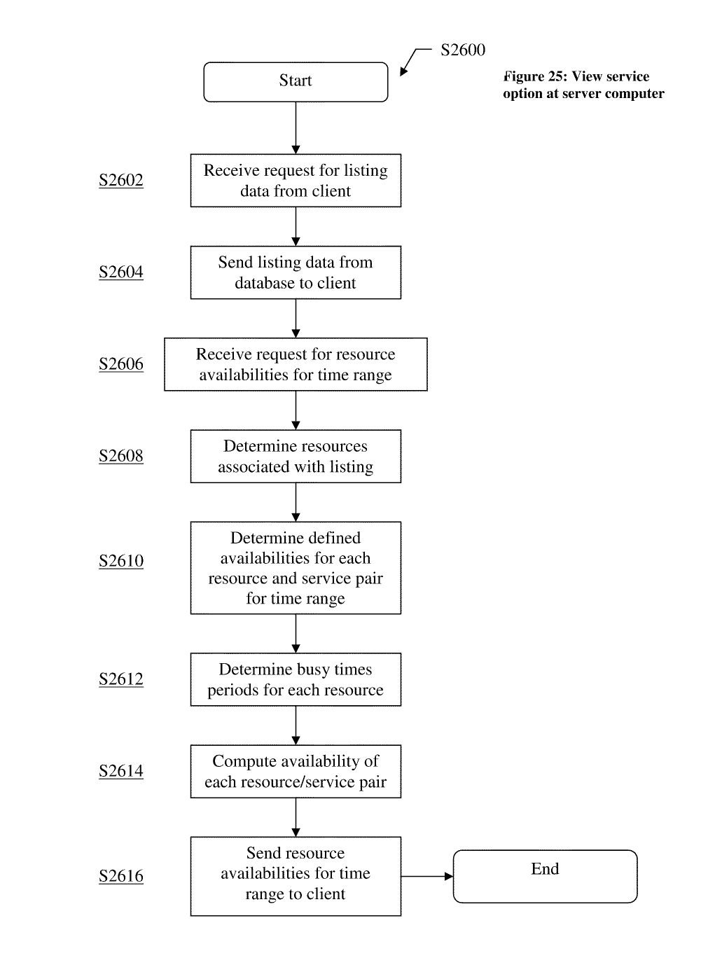

In operation, system 200, upon receiving a request for listing data (e.g. Car Rental Co. Car Rentals) from a prospective customer (flow diagram S2600, S2602, FIG. 25), may responsively send listing data from the database back to the requesting computer (S2604). The prospective customer may then request availabilities for any associated resource for a time range (e.g. Saturday, Apr. 24, 2010). System 200 may receive the request (S2606) and may determine resources associated with the listing (S2608) (e.g. Car Rental Co. rents only economy cars, a “bulk resource”). Next, system 200 may determine defined availabilities for each resource and service pair for the specified time range (e.g. availability of economy cars by Car Rental Co. Car Rentals on Saturday, Apr. 24, 2010) (S2610), and may also determine busy times periods for each resource (e.g. may determine the busy times for the economy cars) (S2612). The availability of each resource for the given listing in the specified time period may then be computed and sent to the prospective customer's computer (S2614, S2616). Availability of each resource (i.e. free times for each resource) may be calculated by subtracting its available calendar from its busy calendar, as previously described.

Having described operation of system 200 from the server computer's perspective, operation of system 200 from a customer's perspective will now be described in conjunction with FIGS. 12-14 and 20.

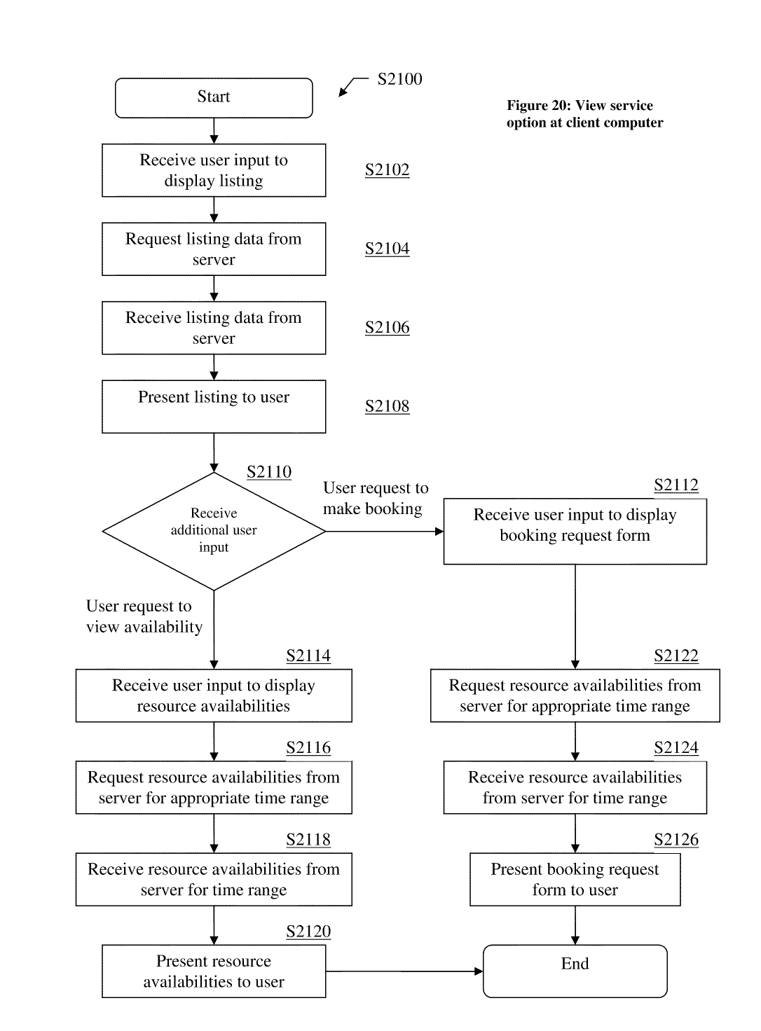

FIG. 12 is a screenshot of an exemplary view listing screen 1300 that may be displayed in response to receipt of a customer request for that service (S2102-S2108, FIG. 20). In particular, view listing screen 1300 displays a resource listing for a cold call service offered by service provider jughead, in the “Business/Legal>Legal>Lawyers” category. An associated price, location and description are also displayed.

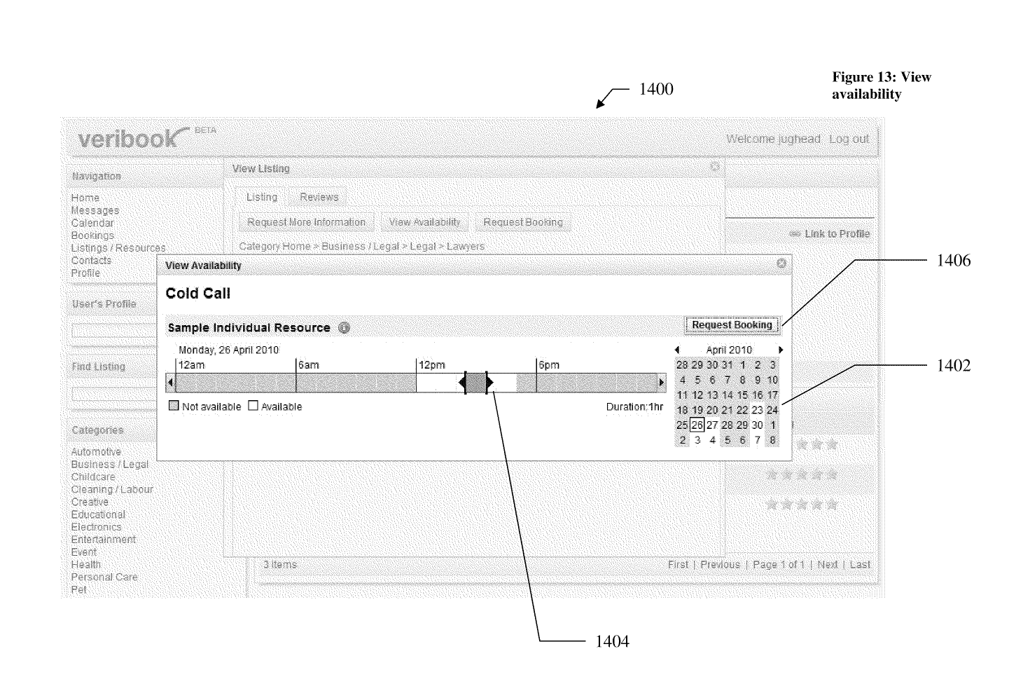

A prospective customer desiring to book jughead's cold call service may request to view the availability of any associated resources, in this example, only “Sample Individual Resource”. Responsive to this request, exemplary view availability screen 1400 (FIG. 13) may be presented to the customer (S2110, S2114). Conveniently, the prospective customer may select a date on the calendar 1402 and may then scroll back and forth along the horizontal timeline 1404 to determine time periods during which “Sample Individual Resource” is available. Conveniently, the availability of “Sample Individual Resource” may be requested from server 202 in the above-described manner, received, and presented (S2116-2120). Upon identifying a satisfactory available timeslot, the customer may then proceed to request a booking with “Sample Individual Resource” by clicking on Request Booking button 1406.

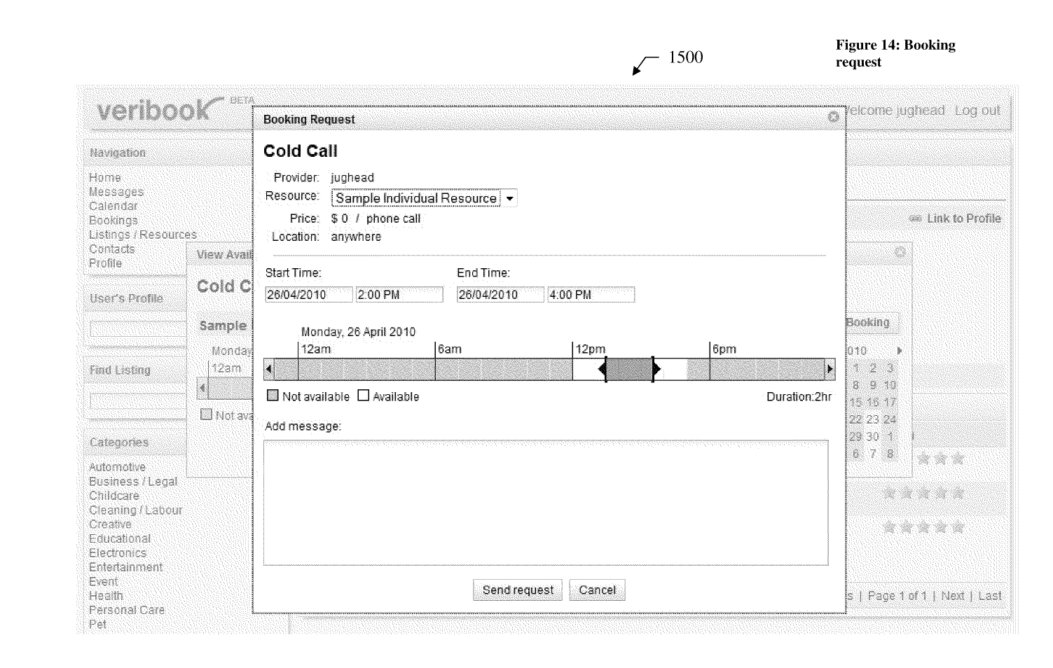

Alternatively, the customer may request a booking request form (S2110, S2112) by clicking on Request Booking button 1302 on form 1300. Responsive to this request, the customer may be presented with exemplary Booking Request screen 1500 (FIG. 14). The customer may optionally enter further details and confirm the details of the booking before sending the booking request. Likewise, the availabilities of the requested resource may be requested from server 202 in the manner described above, received, and presented (S2122-S2126).

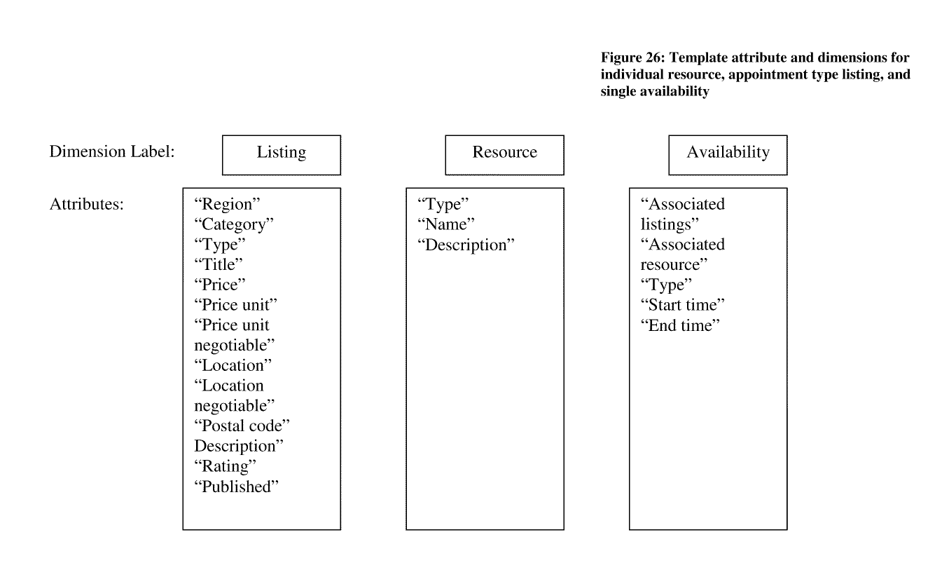

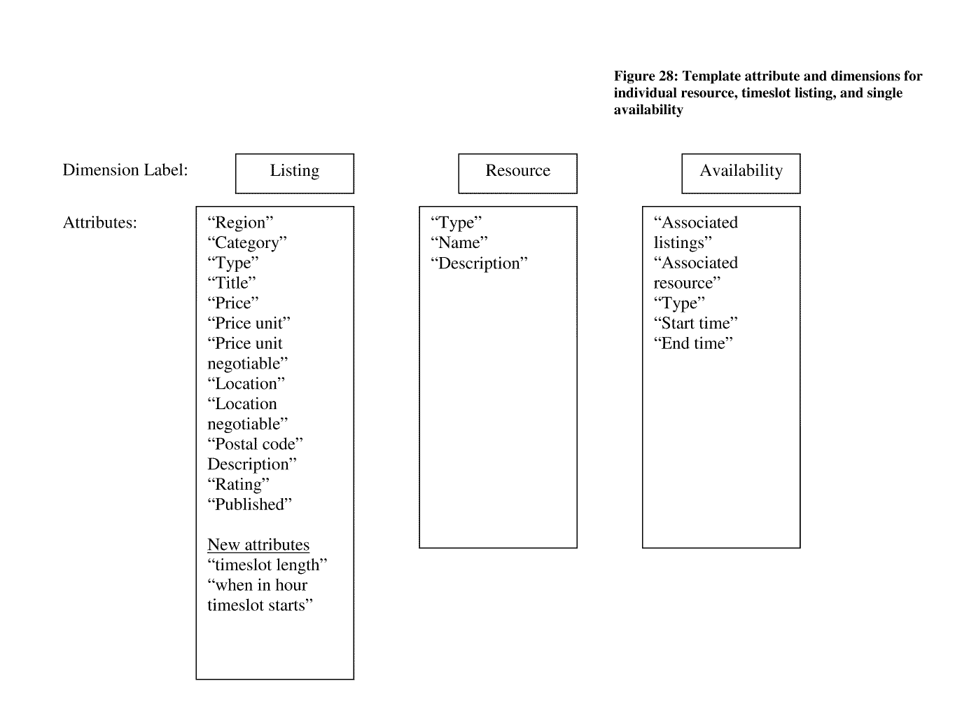

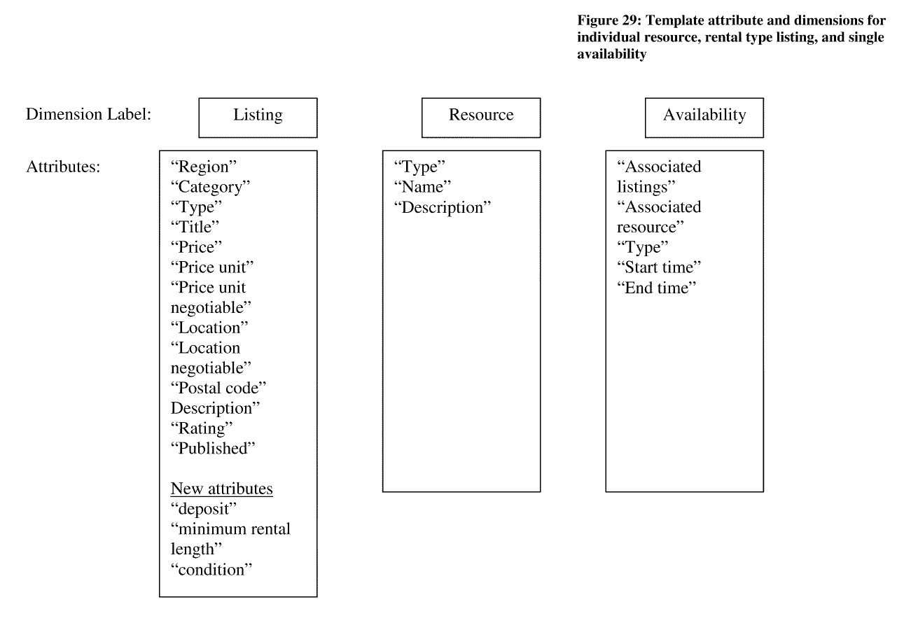

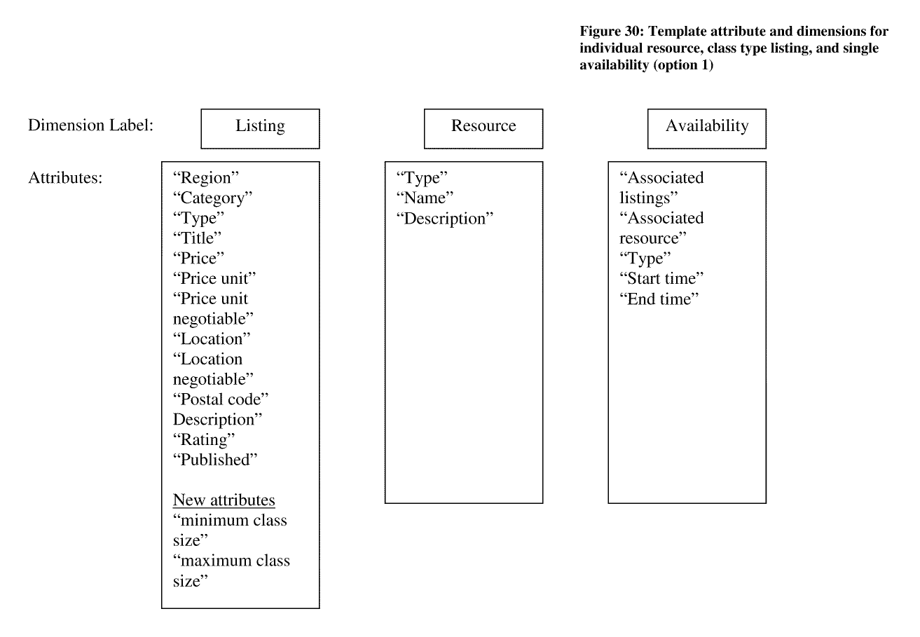

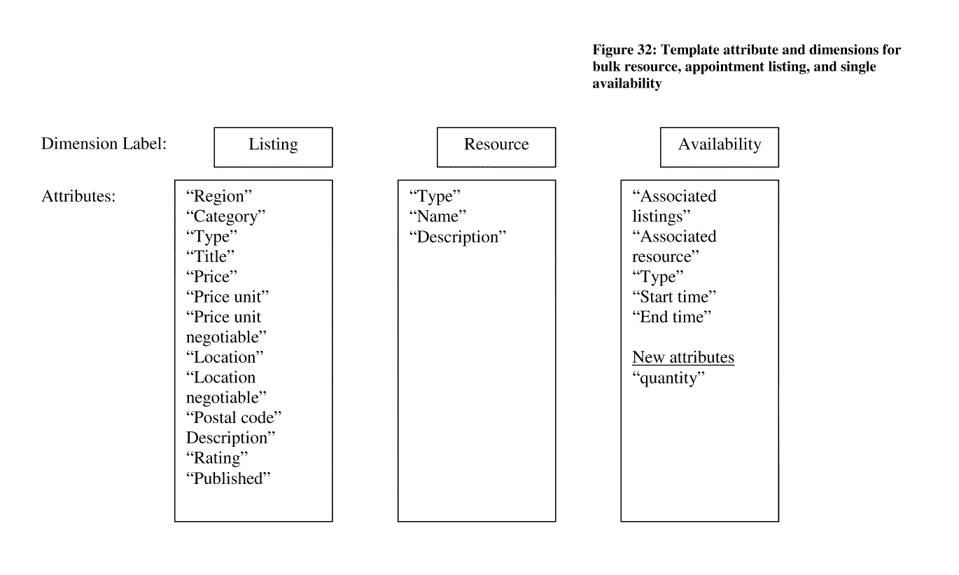

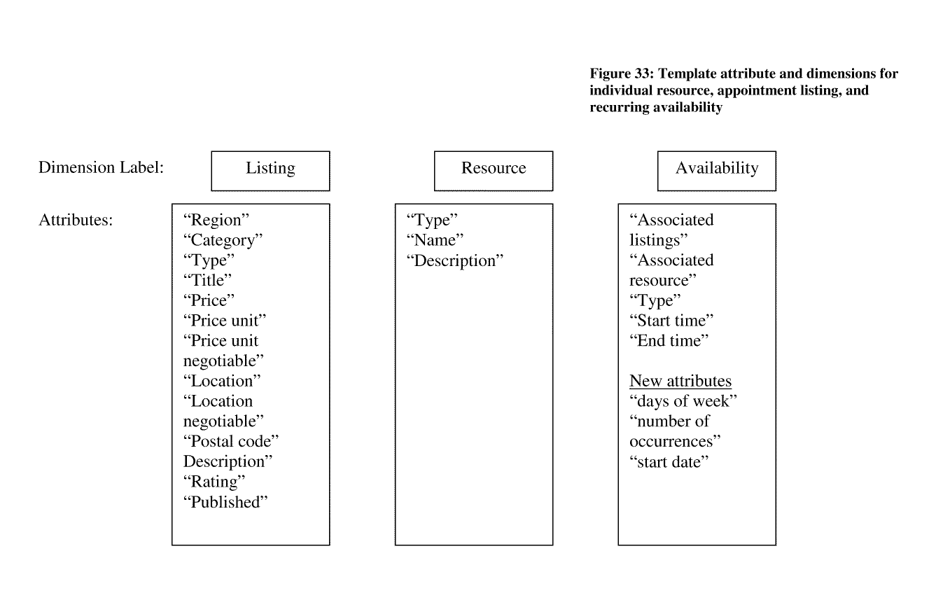

Operation of system 200 to provide the above-described functionality will be further detailed below in conjunction with FIGS. 26 to 35.

FIG. 26 is a block diagram illustrating a template for how system 200 may model an individual resource, an appointment type listing and a single availability. Specifically, each is associated with a plurality of attributes, i.e. “region”, “category”, “type”, “title”, “price”, etc., and the plurality of attributes are divided into three dimensions (or sets): listing, resource and availability. Upon receiving a request to create an individual resource, an appointment type listing or a single availability, system 200 may automatically associate with it the illustrated attributes, which attributes are divided out into the three sets illustrated.

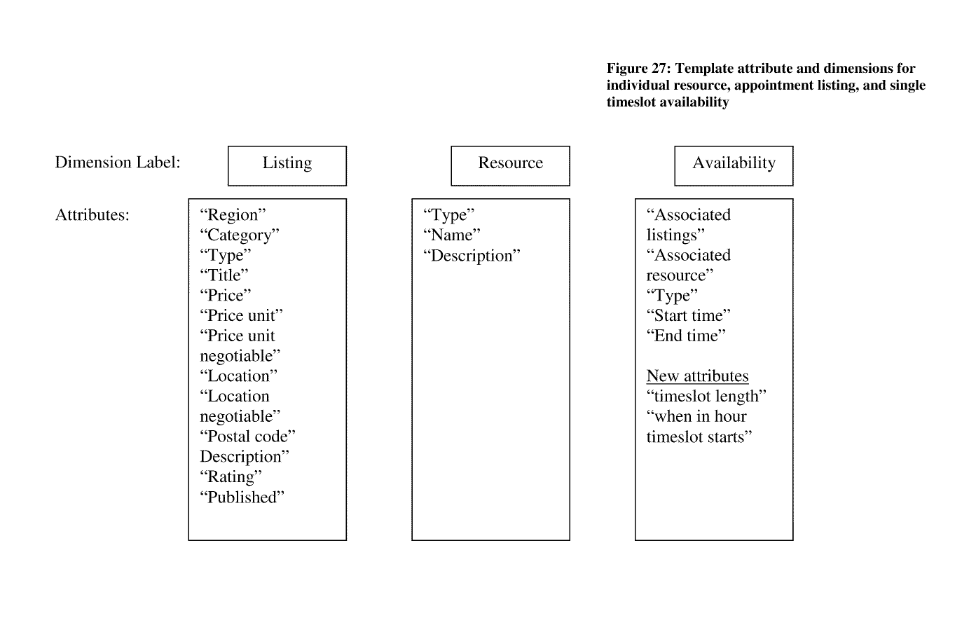

As shown in FIGS. 27 to 33, templates may be provided for other exemplary models. For example, in FIG. 27, when a single timeslot availability is created, new attributes “timeslot length” and “when in hour timeslot starts” may be added in the “Availability” dimension/set. These two attributes may not form part of the template for, for example, a single availability, because there may be no timeslots associated with a single availability that is designed to allow freeform bookings, as for example depicted in FIG. 13.

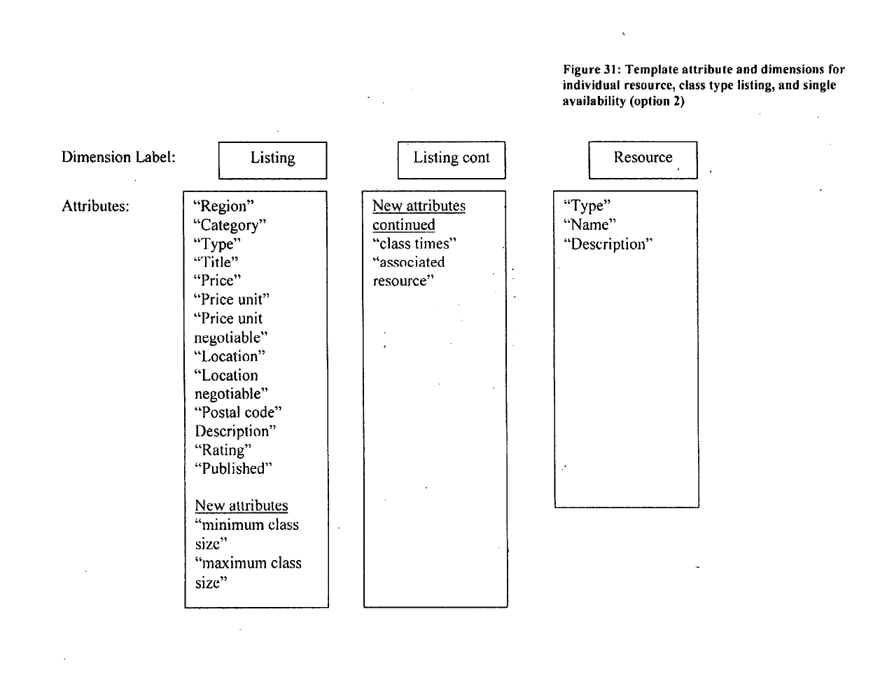

Notably, a template may contain lesser or more numbers of dimensions/sets. This is shown in, for example, FIG. 31, where the exemplary template only includes two dimensions/sets: listing and resource. Of course, the templates depicted in FIGS. 27-33 are exemplary only and it may be appreciated that other attributes, dimensions/sets and division of attributes amongst the dimensions/sets may be defined. Moreover, the assignment of values to one or more attributes associated with a dimension, in the course of operation of system 200, may result in the association of certain other attributes with another particular dimension.

In the exemplary embodiment, for a given template, the attributes, the dimensions/sets, and the division of attributes amongst the dimensions/sets may be chosen by the designers of system 200 to generally correspond to the needs of one or more classes of businesses and their corresponding business model(s) for offering available resources.

Thus, conveniently, when a seller creates a new resource and associated resource listing, an appropriate template may be selected (and further may be modified dynamically) by system 200 based on information provided by the seller. In this manner, the type of business may be more accurately modelled by system 200 in contrast to generic systems in the past.

Upon request by a prospective customer to view availability of a given resource, the attributes within each dimensions/sets may be combinable with attributes in other dimension/sets to uniquely identify an instance of a resource. This may take the form of, for example, a conventional database query.

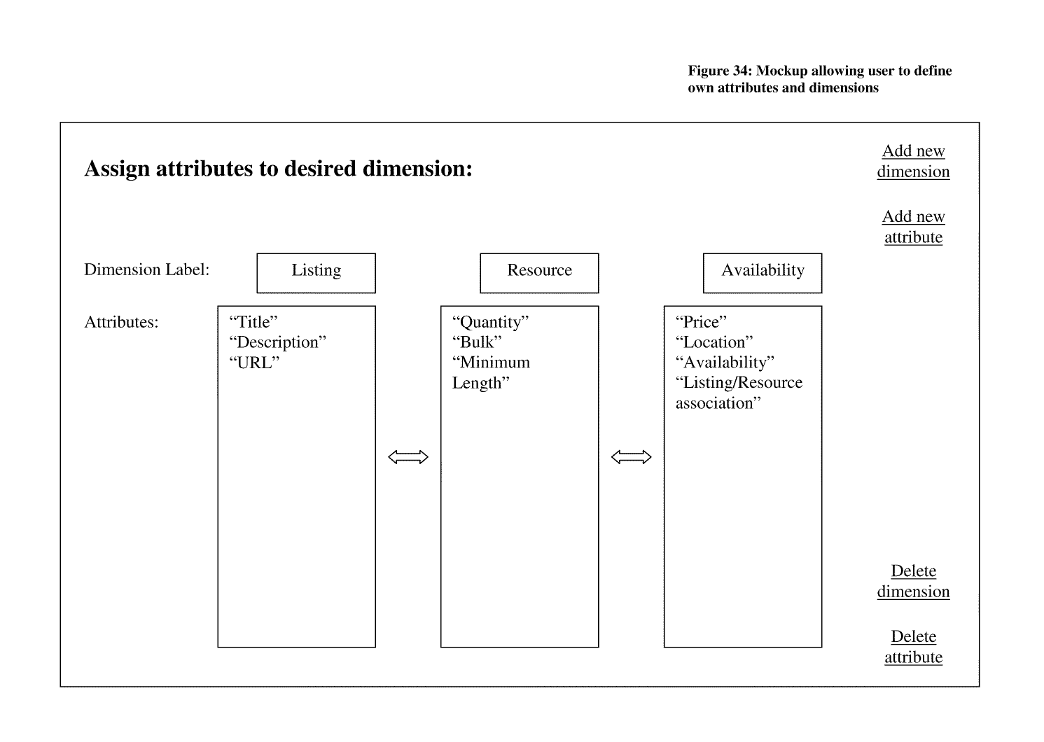

In an alternate embodiment of the invention, instead of system 200 associating template attributes and dimensions/sets to a resource, the seller may itself define attributes and dimensions/set and a division of those attributes amongst the dimensions/sets, as shown in FIG. 34. It may be appreciated that this provides further flexibility to system 200 in that a seller may more accurately represent his or her resource(s) and business model(s) than if system 200 were to apply pre-existing templates.

While the above-described embodiment assumes that the offerors of the resources are sellers of wares and services, it may be appreciated that the invention may equally accommodate business models wherein the offeror is not providing wares and services in exchange for money. Indeed, system 200 may be flexible enough to accommodate other models wherein offerors of the resources are offering free wares and services, or more generally, when bookings are needed for wares and services, for example, a consultation with a bank officer or lawyer, a viewing of a home, a time for a teleconference, use of a condominium party room, or sharing of a car.

Furthermore, it may be appreciated that the flow diagrams described above are exemplary only, and the sequence of operations depicted in the flow diagrams may be modified without affecting the intended function of the operation.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A computer-implemented method for listing available resources in a client-server e-commerce system, said method comprising:
receiving from a first seller a first listing of at least one resource offered by said first seller;
receiving from a second seller a second listing of at least one resource offered by said second seller;
for each resource of said first and second listings
receiving an indication of attributes of said resource;
receiving an indication of relationships between said attributes; and
based on said received indication of attributes and said indication of relationships, dividing said attributes into at least two sets, wherein said dividing of said attributes is characteristic of an organizational structure offering services.

2. The method of claim 1 further comprising consequent upon receiving a customer request presenting to said customer a representation of identified available instances of a given resource.

3. The method of claim 1 wherein said receiving an indication of relationships between said attributes comprises receiving said indication from said seller of said resource and wherein said dividing is based on pre-defined rules in accordance with said organizational structure of said seller.

4. The method of claim 1 wherein said receiving an indication of relationships between said attributes comprises receiving an indication of a resource type and assigning pre-defined relationships between said attributes based on a pre-defined association between type of resource, attributes and relationships between said attributes in accordance with characteristics of a given organizational structure.

5. The method of claim 1 wherein said attributes comprises at least one of: a date, a time and a location at which said resource is available.

6. The method of claim 1 wherein said resource is one of: a service and a product.

7. The method of claim 1 wherein said receiving an indication of attributes comprises receiving an indication of a type of resource from said seller of said listed resource and based on said indicator of type of resource, selecting attributes from a pre-defined template wherein said template associates type of resource to attributes.

8. The method of claim 1 wherein said receiving an indication of attributes comprises receiving said attributes from said seller of said listed resource.

9. A computer-implemented method for presenting service option availability in a client-server e-commerce system, said method comprising:
receiving from a seller a definition of a service option offered by said seller;
receiving from said seller an indication of a plurality of attributes of said service option;
receiving from said seller an indication of at least one relationship between said attributes of said service option;
based on said received at least one relationship, dividing said attributes into at least two sets, wherein said dividing of said attributes is characteristic of an organizational structure offering services.

10. The method of claim 9 further comprising:
consequent upon receiving a customer request for a given service option, selectively combining at least two sets of said at least two sets to thereby identify at least one instance of an available service option.

11. The method of claim 9 further comprising:
presenting to said seller a form for providing said indication of a plurality of attributes; and
presenting to said seller another form for providing said at least one relationship between said attributes.

12. A computer-implemented method for storing a plurality of service listings in
a client-server e-commerce system, said method comprising:
defining a first service dimension and a plurality of members of said first service dimension, each member of said first plurality of members comprising a set of values, wherein each value corresponds to an attribute of a given service;
storing said first plurality of members of said first service dimension;
defining a second service dimension and a plurality of members of said second service dimension, each member of said second plurality of members comprising a set of values, wherein each value corresponds to another attribute of said given service;
storing said second plurality of members of said second service dimension;
defining a third service dimension and a plurality of members of said third service dimension, each member of said third plurality of members comprising a set of values, wherein each value defines a relationship between a member of said first service dimension and a member of said second service dimension; and
storing said third set of members of said third service dimension,
wherein said first, said second and said third service dimensions are collectively characteristic of an organizational structure offering services.

13. The method of claim 12 wherein said defining and storing said third plurality of members further comprises storing another set of values wherein each value of said another set is an identifier of a service attribute.

14. The method of claim 12 further comprising:
defining a fourth service dimension and plurality of members of said fourth service dimension, each member of said fourth plurality of instances comprising a set of values wherein each value corresponds to a service attribute, and wherein each member of said third plurality of instances further defines a relationship between a member of said first service dimension, a member of said second service dimension, and a member of said fourth service dimension.

15. The method of claim 12 wherein said first plurality of instance comprises a member corresponding to a first service model, and a member corresponding to a second service model, and wherein said first service model and said second service model comprise different service attributes.

16. The method of claim 15 wherein said second plurality of instances comprises at least one instance corresponding to said first service model, and at least one instance corresponding to said second service model.
